(19) United States
(12) Patent Application Publication
(10) Pub. No.: US 2026/0039947 A1
(43) Pub. Date: Feb. 5, 2026

(54) Feedback Based on Position Relative to a Target Depth Range

(71) Applicant: Apple Inc., Cupertino, CA (US)

(72) Inventors: In Young Yang, Kirkland, WA (US); Paulo R Jansen dos Reis, San Jose, CA (US); Peter Burgner, Venice, CA (US)

(21) Appl. No.: 18/639,269

(22) Filed: Apr. 18, 2024

Related U.S. Application Data
(60) Provisional application No. 63/499,016, filed on Apr. 28, 2023.
(60) Provisional application No. 63/585,523, filed on Sep. 26, 2023.

(51) Int. Cl. H04N 23/60; G06V 20/62; G06V 30/14; H04N 23/63

(52) U.S. Cl. CPC H04N 23/64; G06V 20/63; G06V 30/14; H04N 23/635

(57) ABSTRACT

A head-mounted device may include a camera with a target depth range. The camera may capture images of physical objects that include text for optical character recognition (OCR). In one arrangement, no images from the camera are presented to the user during OCR. Accordingly, it may not be apparent to the user when the images captured by the camera are blurry, when the physical object is outside the target depth range, or when OCR is not able to be performed with a high accuracy. To allow the user to easily determine when the physical object is outside the target depth range, the head-mounted device may provide audio and/or visual feedback. Presenting visual feedback may include displaying text instructions, adjusting an appearance of a visual indicator that is aligned with the physical object, or displaying a virtual object at a depth that is within the target depth range.

This application claims the benefit of U.S. provisional patent application No. 63/585,523, filed Sep. 26, 2023, and U.S. provisional patent application No. 63/499,016 filed Apr. 28, 2023, which are hereby incorporated by reference herein in their entireties.

### BACKGROUND

This relates generally to electronic devices, and, more particularly, to electronic devices with cameras.

Some electronic devices such as head-mounted devices use cameras to capture images of nearby physical objects. However, a camera may have a limited range within which objects are properly focused.

### SUMMARY

An electronic device may include one or more sensors including a camera with an associated target depth range, one or more see-through displays, one or more processors, and memory storing instructions configured to be executed by the one or more processors, the instructions for using the one or more see-through displays, presenting a visual indicator that is aligned with an object of interest viewable through the one or more see-through displays, determining whether the object of interest is within the target depth range, and in response to determining that the object of interest is not within the target depth range, adjusting an appearance of the visual indicator that is aligned with the object of interest.

An electronic device may include one or more sensors including a camera with an associated target depth range, one or more output devices, one or more processors, and memory storing instructions configured to be executed by the one or more processors, the instructions for obtaining, via a first subset of the one or more sensors, a depth for an object of interest, determining whether the depth for the object of interest is within the target depth range for the camera, and in response to determining that the depth of the object of interest is outside the target depth range for the camera, presenting feedback using the one or more output devices.

### BRIEF DESCRIPTION OF THE DRAWINGS

FIG. 1 is a schematic diagram of an illustrative electronic device in accordance with some embodiments.

FIG. 2A is a top view of a three-dimensional environment including an illustrative electronic device and a physical object that is positioned within a target depth range for a camera in the head-mounted device in accordance with some embodiments.

FIG. 2B is a view of the physical object in FIG. 2A through the display of the head-mounted device in FIG. 2A in accordance with some embodiments.

FIG. 2C is a view of an image captured by the camera in the head-mounted device of FIG. 2A in accordance with some embodiments.

FIG. 3A is a top view of a three-dimensional environment including an illustrative electronic device and a physical object that is positioned further than a target depth range for a camera in the head-mounted device in accordance with some embodiments.

FIG. 3B is a view of the physical object in FIG. 3A through the display of the head-mounted device in FIG. 3A in accordance with some embodiments.

FIG. 3C is a view of an image captured by the camera in the head-mounted device of FIG. 3A in accordance with some embodiments.

FIG. 4A is a top view of a three-dimensional environment including an illustrative electronic device and a physical object that is positioned closer than a target depth range for a camera in the head-mounted device in accordance with some embodiments.

FIG. 4B is a view of the physical object in FIG. 4A through the display of the head-mounted device in FIG. 4A in accordance with some embodiments.

FIG. 4C is a view of an image captured by the camera in the head-mounted device of FIG. 4A in accordance with some embodiments.

FIG. 5 is a view of an illustrative display with a visual indicator aligned with a physical object in accordance with some embodiments.

FIG. 6 is a view of an illustrative display with a text instruction to move the physical object closer in accordance with some embodiments.

FIG. 7 is a view of an illustrative display with a visual indicator that expands outward in an animation in accordance with some embodiments.

FIG. 8 is a view of an illustrative display with a text instruction to move the physical object further away in accordance with some embodiments.

FIG. 9 is a view of an illustrative display with a visual indicator that contracts inward in an animation in accordance with some embodiments.

FIG. 10 is a view of an illustrative display with a visual indicator that is blurred in accordance with some embodiments.

FIG. 11 is a top view of a three-dimensional environment including an illustrative electronic device, a physical object that is positioned outside a target depth range for a camera in the head-mounted device, and a virtual object that is presented inside the target depth range in accordance with some embodiments.

FIG. 12A is a top view of a three-dimensional environment including an illustrative electronic device and a physical object that is at an angle relative to the head-mounted device in accordance with some embodiments.

FIG. 12B is a view of an illustrative display such as the display in FIG. 12A with a text instruction to rotate the physical object to face the camera in accordance with some embodiments.

FIG. 13 is a flowchart showing an illustrative method for operating an electronic device that presents feedback when an object of interest is outside a target depth range in accordance with some embodiments.

FIG. 14 is a flowchart showing an illustrative method for operating an electronic device that changes the appearance of a visual indicator that is aligned with a physical object when the physical object is outside a target depth range in accordance with some embodiments.

### DETAILED DESCRIPTION

Head-mounted devices may display different types of extended reality content for a user. The head-mounted device may display a virtual object that is perceived at an apparent depth within the physical environment of the user. Virtual objects may sometimes be displayed at fixed locations relative to the physical environment of the user. For example, consider an example where a user's physical environment includes a table. A virtual object may be displayed for the user such that the virtual object appears to be resting on the table. As the user moves their head and otherwise interacts with the XR environment, the virtual object remains at the same, fixed position on the table (e.g., as if the virtual object were another physical object in the XR environment). This type of content may be referred to as world-locked content (because the position of the virtual object is fixed relative to the physical environment of the user).

Other virtual objects may be displayed at locations that are defined relative to the head-mounted device or a user of the head-mounted device. First, consider the example of virtual objects that are displayed at locations that are defined relative to the head-mounted device. As the head-mounted device moves (e.g., with the rotation of the user's head), the virtual object remains in a fixed position relative to the head-mounted device. For example, the virtual object may be displayed in the front and center of the head-mounted device (e.g., in the center of the device's or user's field-of-view) at a particular distance. As the user moves their head left and right, their view of their physical environment changes accordingly. However, the virtual object may remain fixed in the center of the device's or user's field of view at the particular distance as the user moves their head (assuming gaze direction remains constant). This type of content may be referred to as head-locked content. The head-locked content is fixed in a given position relative to the head-mounted device (and therefore the user's head which is supporting the head-mounted device). The head-locked content may not be adjusted based on a user's gaze direction. In other words, if the user's head position remains constant and their gaze is directed away from the head-locked content, the head-locked content will remain in the same apparent position.

Second, consider the example of virtual objects that are displayed at locations that are defined relative to a portion of the user of the head-mounted device (e.g., relative to the user's torso). This type of content may be referred to as body-locked content. For example, a virtual object may be displayed in front and to the left of a user's body (e.g., at a location defined by a distance and an angular offset from a forward-facing direction of the user's torso), regardless of which direction the user's head is facing. If the user's body is facing a first direction, the virtual object will be displayed in front and to the left of the user's body. While facing the first direction, the virtual object may remain at the same, fixed position relative to the user's body in the XR environment despite the user rotating their head left and right (to look towards and away from the virtual object). However, the virtual object may move within the device's or user's field of view in response to the user rotating their head. If the user turns around and their body faces a second direction that is the opposite of the first direction, the virtual object will be repositioned within the XR environment such that it is still displayed in front and to the left of the user's body. While facing the second direction, the virtual object may remain at the same, fixed position relative to the user's body in the XR environment despite the user rotating their head left and right (to look towards and away from the virtual object).

In the aforementioned example, body-locked content is displayed at a fixed position/orientation relative to the user's body even as the user's body rotates. For example, the virtual object may be displayed at a fixed distance in front of the user's body. If the user is facing north, the virtual object is in front of the user's body (to the north) by the fixed distance. If the user rotates and is facing south, the virtual object is in front of the user's body (to the south) by the fixed distance.

Alternatively, the distance offset between the body-locked content and the user may be fixed relative to the user whereas the orientation of the body-locked content may remain fixed relative to the physical environment. For example, the virtual object may be displayed in front of the user's body at a fixed distance from the user as the user faces north. If the user rotates and is facing south, the virtual object remains to the north of the user's body at the fixed distance from the user's body.

Body-locked content may also be configured to always remain gravity or horizon aligned, such that head and/or body changes in the roll orientation would not cause the body-locked content to move within the XR environment. Translational movement may cause the body-locked content to be repositioned within the XR environment to maintain the fixed distance from the user. Subsequent descriptions of body-locked content may include both of the aforementioned types of body-locked content.

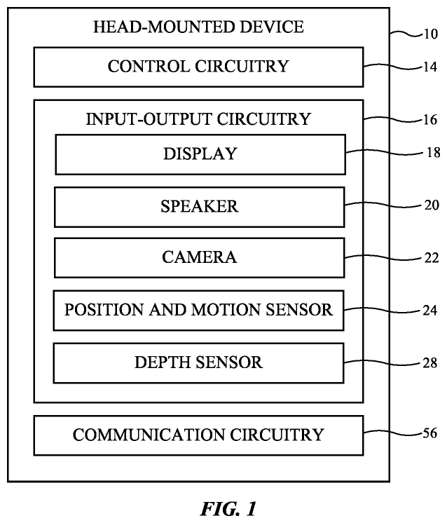

A schematic diagram of an illustrative electronic device is shown in FIG. 1. As shown in FIG. 1, electronic device 10 (sometimes referred to as head-mounted device 10, system 10, head-mounted display 10, etc.) may have control circuitry 14. In addition to being a head-mounted device, electronic device 10 may be other types of electronic devices such as a cellular telephone, laptop computer, speaker, computer monitor, electronic watch, tablet computer, etc.

Control circuitry 14 may be configured to perform operations in head-mounted device 10 using hardware (e.g., dedicated hardware or circuitry), firmware and/or software. Software code for performing operations in head-mounted device 10 and other data is stored on non-transitory computer readable storage media (e.g., tangible computer readable storage media) in control circuitry 14. The software code may sometimes be referred to as software, data, program instructions, instructions, or code. The non-transitory computer readable storage media (sometimes referred to generally as memory) may include non-volatile memory such as non-volatile random-access memory (NVRAM), one or more hard drives (e.g., magnetic drives or solid-state drives), one or more removable flash drives or other removable media, or the like. Software stored on the non-transitory computer readable storage media may be executed on the processing circuitry of control circuitry 14. The processing circuitry may include application-specific integrated circuits with processing circuitry, one or more microprocessors, digital signal processors, graphics processing units, a central processing unit (CPU) or other processing circuitry.

Head-mounted device 10 may include input-output circuitry 16. Input-output circuitry 16 may be used to allow a user to provide head-mounted device 10 with user input. Input-output circuitry 16 may also be used to gather information on the environment in which head-mounted device 10 is operating. Output components in circuitry 16 may allow head-mounted device 10 to provide a user with output.

As shown in FIG. 1, input-output circuitry 16 may include a display such as display 18. Display 18 may be used to display images for a user of head-mounted device 10. Display 18 may be a transparent or translucent display so that a user may observe physical objects through the display while computer-generated content is overlaid on top of the physical objects by presenting computer-generated images on the display. A transparent or translucent display may be formed from a transparent or translucent pixel array (e.g., a transparent organic light-emitting diode display panel) or may be formed by a display device that provides images to a user through a transparent structure such as a beam splitter, holographic coupler, or other optical coupler (e.g., a display device such as a liquid crystal on silicon display). Alternatively, display 18 may be an opaque display that blocks light from physical objects when a user operates head-mounted device 10. In this type of arrangement, a pass-through camera may be used to display physical objects to the user. The pass-through camera may capture images of the physical environment and the physical environment images may be displayed on the display for viewing by the user. Additional computer-generated content (e.g., text, game-content, other visual content, etc.) may optionally be overlaid over the physical environment images to provide an extended reality environment for the user. When display 18 is opaque, the display may also optionally display entirely computer-generated content (e.g., without displaying images of the physical environment).

Display 18 may include one or more optical systems (e.g., lenses) (sometimes referred to as optical assemblies) that allow a viewer to view images on display(s) 18. A single display 18 may produce images for both eyes or a pair of displays 18 may be used to display images. In configurations with multiple displays (e.g., left and right eye displays), the focal length and positions of the lenses may be selected so that any gap present between the displays will not be visible to a user (e.g., so that the images of the left and right displays overlap or merge seamlessly). Display modules (sometimes referred to as display assemblies) that generate different images for the left and right eyes of the user may be referred to as stereoscopic displays. The stereoscopic displays may be capable of presenting two-dimensional content (e.g., a user notification with text) and three-dimensional content (e.g., a simulation of a physical object such as a cube).

Display 18 may include an organic light-emitting diode display or other displays based on arrays of light-emitting diodes, a liquid crystal display, a liquid-crystal-on-silicon display, a projector or display based on projecting light beams on a surface directly or indirectly through specialized optics (e.g., digital micromirror devices), an electrophoretic display, a plasma display, an electrowetting display, or any other desired display.

Input-output circuitry 16 may include various other input-output devices. For example, input-output circuitry 16 may include one or more speakers 20 that are configured to play audio and one or more microphones that are configured to capture audio data from the user and/or from the physical environment around the user.

Input-output circuitry 16 may include one or more cameras 22. Cameras 22 may include one or more outward-facing cameras (that face the physical environment around the user when the electronic device is mounted on the user's head, as one example). Cameras 22 may capture visible light images, infrared images, or images of any other desired type. The cameras may be stereo cameras if desired. Outward-facing cameras may capture pass-through video for device 10. Cameras 22 may also include inward-facing cameras (e.g., for gaze detection).

As shown in FIG. 1, input-output circuitry 16 may include position and motion sensors 24 (e.g., compasses, gyroscopes, accelerometers, and/or other devices for monitoring the location, orientation, and movement of electronic device 10, satellite navigation system circuitry such as Global Positioning System circuitry for monitoring user location, etc.). Using sensors 24, for example, control circuitry 14 can monitor the current direction in which a user's head is oriented relative to the surrounding environment (e.g., a user's head pose). The cameras in cameras 22 may also be considered part of position and motion sensors 24. The cameras may be used for face tracking (e.g., by capturing images of the user's jaw, mouth, etc. while the device is worn on the head of the user), body tracking (e.g., by capturing images of the user's torso, arms, hands, legs, etc. while the device is worn on the head of user), and/or for localization (e.g., using visual odometry, visual inertial odometry, or other simultaneous localization and mapping (SLAM) technique).

Input-output circuitry 16 may include one or more depth sensors 28. Each depth sensor may be a pixelated depth sensor (e.g., that is configured to measure multiple depths across the physical environment) or a point sensor (that is configured to measure a single depth in the physical environment). Each depth sensor (whether a pixelated depth sensor or a point sensor) may use phase detection (e.g., phase detection autofocus pixel(s)) or light detection and ranging (LIDAR) to measure depth. Camera images (e.g., from one of cameras 22) may also be used for monocular and/or stereo depth estimation. Any combination of depth sensors may be used to determine the depth of physical objects in the physical environment.

Input-output circuitry 16 may also include other sensors and input-output components if desired (e.g., buttons, gaze detection sensors, ambient light sensors, force sensors, temperature sensors, touch sensors, capacitive proximity sensors, light-based proximity sensors, other proximity sensors, strain gauges, gas sensors, pressure sensors, moisture sensors, magnetic sensors, audio components, haptic output devices such as actuators and/or vibration motors, light-emitting diodes, other light sources, etc.).

Head-mounted device 10 may also include communication circuitry 56 to allow the head-mounted device to communicate with external equipment (e.g., a tethered computer, a portable device, one or more external servers, or other electrical equipment). Communication circuitry 56 may be used for both wired and wireless communication with external equipment. Communication circuitry 56 may include radio-frequency (RF) transceiver circuitry, antennas, etc.

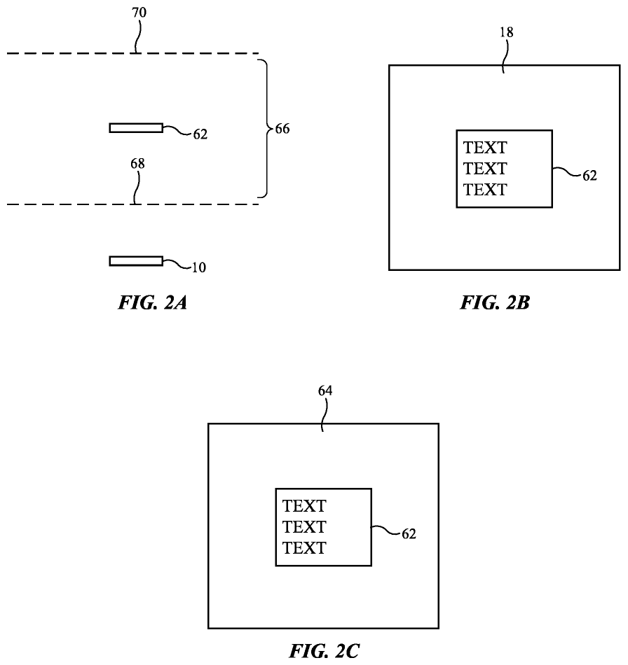

As shown in the view of FIG. 2A, one or more cameras within head-mounted device 10 may have an associated target depth range 66. The target depth range 66 extends between a minimum target depth 68 and a maximum target depth 70. Camera 22 within head-mounted device 10 may be capable of adjusting its focal point to a depth between minimum depth 68 and maximum depth 70. Accordingly, within target depth range 66 the camera 22 can properly focus on a target object. For example, camera 22 can focus on physical object 62 within target depth range 66 in FIG. 2A.

As examples, the target depth range 66 may be centered around a depth of 2 meters, a depth of 1 meter, a depth of 3 meters, a depth of between 1 and 3 meters, a depth of greater than 1 meter, a depth of less than 4 meters, etc. The magnitude of target depth range 66 may be 2 meters, 1 meter, 3 meters, 0.5 meters, greater than 0.3 meters, greater than 0.5 meters, greater than 1 meter, less than 4 meters, etc. As one specific example, minimum depth 68 is 1 meter, maximum depth 70 is 3 meters, and the magnitude of target depth range 66 is 2 meters.

Increasing the magnitude of target depth range 66 may involve adding additional lenses to camera 22. To reduce the cost and complexity of camera 22, the camera may be designed to have a target depth range that is aligned with a common viewing range of physical objects by a user of head-mounted device 10.

FIG. 2A shows an example where physical object 62 is centered within target depth range 66. The physical object may be visible to a user through display 18 (sometimes referred to as see-through display 18), as shown in FIG. 2B. FIG. 2C shows an image 64 captured by camera 22 on head-mounted device 10. In FIG. 2C, image 64 includes a clear image of physical object 62. In other words, because physical object 62 is positioned within the target depth range, the captured image 64 of the physical object is in focus and is not blurry.

In some cases, as shown in FIGS. 2A-2C, physical object 62 may include text. The camera may capture images of the text that are used for optical character recognition (OCR). The physical object may need to be within the target depth range 66 to be captured by camera 22 with sufficient clarity (and/or size) for optical character recognition.

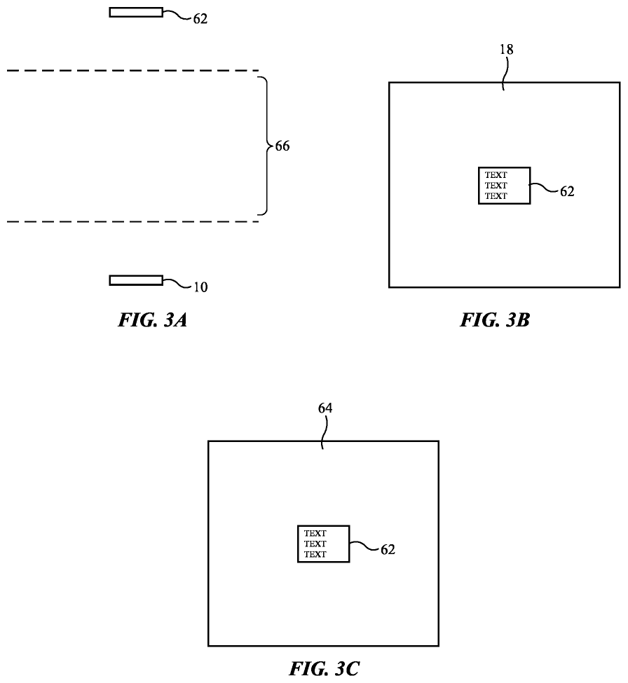

FIG. 3A shows an example where physical object 62 is positioned at a further depth than target depth range 66. The physical object may be visible to a user through display 18, as shown in FIG. 3B. Because the physical object is further away in FIG. 3A than in FIG. 2A, the object appears smaller to the viewer in FIG. 3B than in FIG. 2B. FIG. 3C shows an image 64 captured by camera 22 on head-mounted device 10. In FIG. 3C, image 64 includes an image of physical object 62. However, because physical object 62 is positioned at a further depth than the target depth range, the captured image 64 of the physical object may be blurry.

In FIGS. 3A-3C, physical object 62 again includes text. The camera may capture images of the text that are used for optical character recognition (OCR). However, the depth of the physical object in FIG. 3A being greater than the target depth range causes the text to be too blurry and/or too small to perform optical character recognition with sufficiently high accuracy. Head-mounted device may have a target accuracy for optical character recognition (e.g., 90%, 95%, 99%, etc.). The accuracy of OCR in the arrangement of FIGS. 3A-3C may be less than the target accuracy.

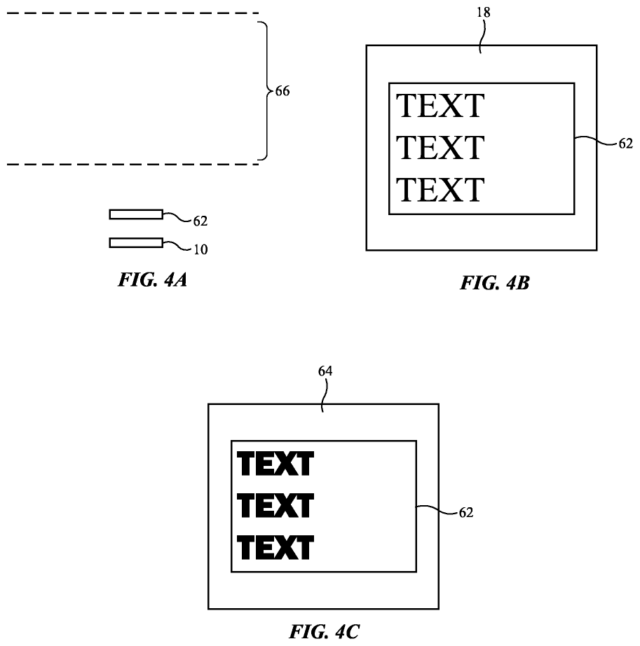

FIG. 4A shows an example where physical object 62 is positioned at a closer depth than target depth range 66. The physical object may be visible to a user through display 18, as shown in FIG. 4B. Because the physical object is closer in FIG. 4A than in FIG. 2A., the object appears larger to the viewer in FIG. 4B than in FIG. 2B. FIG. 4C shows an image 64 captured by camera 22 on head-mounted device 10. In FIG. 4C, image 64 includes an image of physical object 62. However, because physical object 62 is positioned at a closer depth than the target depth range, the captured image 64 of the physical object may be blurry.

In FIGS. 4A-4C, physical object 62 again includes text. The camera may capture images of the text that are used for optical character recognition (OCR). However, the depth of the physical object in FIG. 4A being less than the target depth range causes the text to be too blurry to perform optical character recognition with sufficiently high accuracy. The accuracy of OCR in the arrangement of FIGS. 4A-4C may be less than the target accuracy.

In one possible arrangement, no images from camera 22 are presented to the user during the OCR operations in head-mounted device 10. Accordingly, the user may not be able to easily recognize whether the physical object for OCR is within the target depth range. Consider a scenario where the user wishes to perform OCR on physical object 62. In the arrangements of FIGS. 2A, 3A, and 4A, the physical object may appear clear to the user (because the user's eyes properly focus on the physical object). However, the image of physical object 62 captured by the camera 22 may be blurry when the physical object is outside the target depth range (as in FIG. 3C and/or FIG. 4C). Therefore, it is not apparent to the user that the images captured by the camera of the physical object are blurry, that the physical object is outside the target depth range, or that OCR is not able to be performed with a high accuracy.

To allow the user to easily determine when the physical object is outside the target depth range, head-mounted device 10 may provide feedback to the user when the physical object is outside the target depth range. The feedback may include audio feedback presented using speaker 20 and/or visual feedback presented using display 18. Presenting visual feedback may include displaying text instructions on display 18, adjusting an appearance of a visual indicator that is aligned with the physical object on display 18, displaying a virtual object at a depth that is within the target depth range, or presenting any other desired visual feedback.

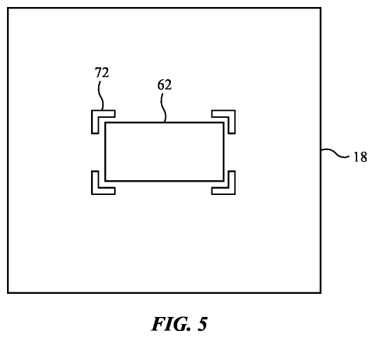

If desired, a visual indicator such as visual indicator 72 (sometimes referred to as reticle 72, outline 72, etc.) may be presented on display 18, as shown in FIG. 5. The reticle may be positioned on see-through display 18 such that the reticle appears to be aligned with physical object 62 when viewed by the user through display 18. In FIG. 5, reticle 72 forms a partial outline around the physical object. The reticle has four discrete portions, each positioned at a corner of the physical object (or at a corner of a rectangular footprint that is approximately the same size as the physical object, in the event the physical object is not rectangular). This example is merely illustrative. In another possible arrangement, reticle 72 may form a complete outline around the physical object 62. In other words, the reticle 72 forms a closed loop at the periphery of physical object 62. In general, the reticle may form at least a partial outline around the physical object.

The example of the visual indicator forming a partial or complete outline around the physical object is merely illustrative. In another possible arrangement, the visual indicator may form a partial or complete outline around text identified in the physical object (e.g., to indicate that OCR is being performed on the identified text).

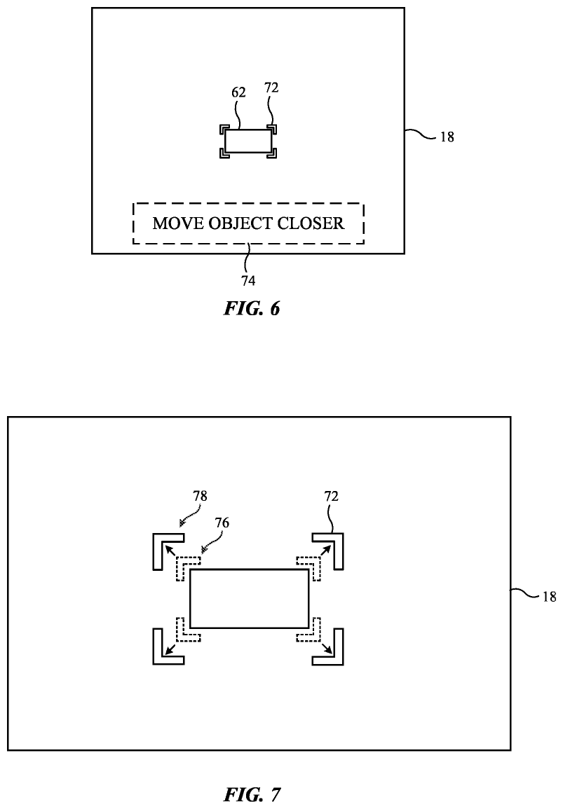

Visual feedback provided to the user when a physical object is outside the target depth range may include changing the appearance of the visual indicator or other desired visual feedback. FIG. 6 shows an example of text feedback that may be displayed when the object of interest is farther from the head-mounted device than the target depth range (e.g., as in FIG. 3A). As shown in FIG. 6, text feedback 74 may be presented on display 18 and may include text such as “move object closer,” “object too far away,” “move object within target depth range,” etc. This type of text feedback may be presented on display 18 without changing the appearance of visual indicator 72. This type of text feedback may also be presented on display 18 when visual indicator 72 is omitted.

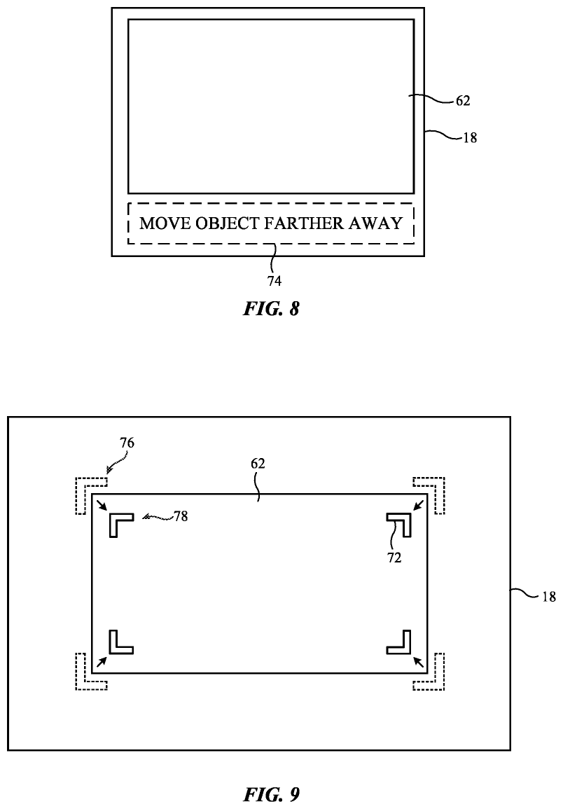

FIG. 7 shows an example of an animation that may be displayed when the object of interest is farther from the head-mounted device than the target depth range (e.g., as in FIG. 3A). As shown in FIG. 7, an animation may be presented in which the visual indicator 72 expands outward (e.g., away from a center of the visual indicator and/or away from a center of the physical object) from an original position 76 to a new position 78 (as indicated by the four arrows in FIG. 7). The visual indicator may sometimes be referred to as expanding radially outwards. The visual indicator may remain at new position 78 after the animation or may revert to original position 76 after the animation. The animation in which visual indicator 72 expands outward in this manner may be presented once or may be presented repeatedly with any desired gap between each animation. The visual indicator expanding outward implies to the user that the physical object should be brought closer to head-mounted device 10, thus increasing the size of the physical object to match the increased size of the visual indicator in the animation. In some examples, the increased size may be based on the size and distance of the object, such that the increased size would correspond to where the object is at the maximum target depth 70 of target depth range 66.

FIG. 8 shows an example of text feedback that may be displayed when the object of interest is closer to the head-mounted device than the target depth range (e.g., as in FIG. 4A). As shown in FIG. 8, text feedback 74 may be presented on display 18 and may include text such as “move object further away,” “object too close,” “move object within target depth range,” etc. As shown in FIG. 8, this type of text feedback may be presented on display 18 when visual indicator 72 is omitted. This type of text feedback may also be presented on display 18 without changing the appearance of a visual indicator in the event that a visual indicator is present.

FIG. 9 shows an example of an animation that may be displayed when the object of interest is closer to the head-mounted device than the target depth range (e.g., as in FIG. 4A). As shown in FIG. 9, an animation may be presented in which the visual indicator 72 contracts inward (e.g., towards a center of the visual indicator and/or towards a center of the physical object) from an original position 76 to a new position 78 (as indicated by the four arrows in FIG. 9). The visual indicator may sometimes be referred to as expanding radially inwards. At new position 78, the visual indicator may overlap physical object 62 from the perspective of the viewer. The visual indicator may remain at new position 78 after the animation or may revert to original position 76 after the animation. The animation in which visual indicator 72 contracts inward in this manner may be presented once or may be presented repeatedly with any desired gap between each animation. The visual indicator contracting inward implies to the user that the physical object should be moved further away from head-mounted device 10, thus decreasing the size of the physical object to match the decreased size of the visual indicator in the animation. In some examples, the decreased size may be based on the size and distance of the object, such that the decreased size would correspond to where the object is at the minimum target depth 68 of target depth range 66.

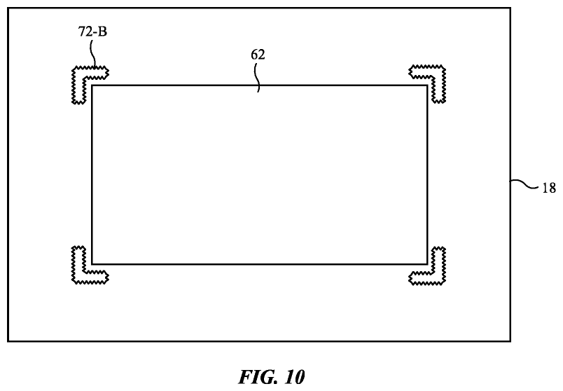

Another possible option for visual feedback when an object of interest is outside the target depth range is to blur the visual indicator 72. FIG. 10 is a view of display 18 with blurred visual indicator 72-B positioned on see-through display 18 such that the blurred visual indicator appears to be aligned with physical object 62 when viewed by the user through display 18. Any desired type of blur (e.g., a gaussian blur) may be applied to the visual indicator. The amount of blur applied to visual indicator 72-B may increase as the distance of physical object from the target depth range increases.

For example, the target depth range may be 1-3 meters. At a first time, a physical object is positioned at a depth of 2 meters (e.g., within the target depth range). At the first time, the visual indicator is displayed with a first magnitude of blur (e.g., without any blur). At a second time, a physical object is positioned at a depth of 3.5 meters (e.g., outside the target depth range). At the second time, the visual indicator is displayed with a second magnitude of blur (e.g., a non-zero magnitude of blur) that is greater than the first magnitude. At a third time, a physical object is positioned at a depth of 4.5 meters (e.g., outside the target depth range). At the third time, the visual indicator is displayed with a third magnitude of blur that is greater than the second magnitude. In other words, the magnitude of blur is proportional (though not necessarily linearly proportional) to a difference between the depth of the physical object and the target depth range. This trend holds true both as the depth becomes greater than the maximum target depth and as the depth becomes smaller than the minimum target depth.

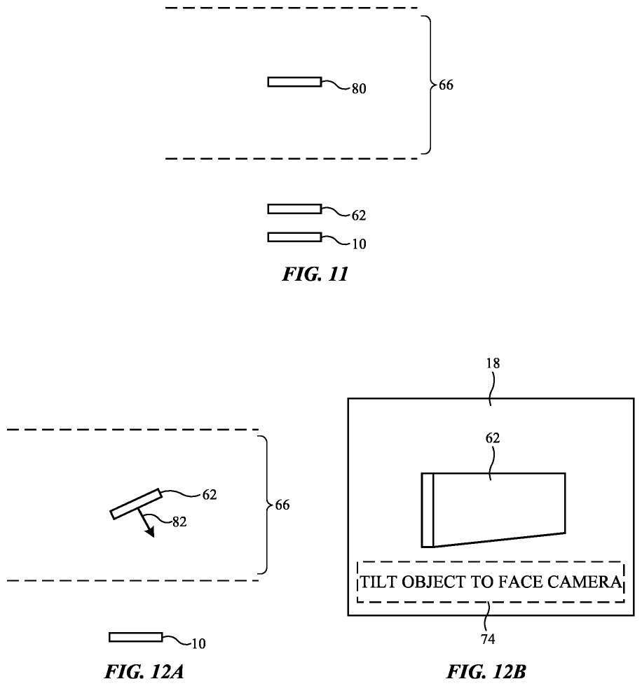

In another possible arrangement, shown in FIG. 11, display 18 in head-mounted device 10 may be used to display a virtual object 80 within target depth range 66 in response to the physical object 62 being outside of the target depth range. The virtual object within the target depth range 66 may serve as an indicator to the user for where to position physical object 62. To allow virtual object 80 to be displayed at a perceived depth that is within target depth range 66, display 18 may be a stereoscopic display. Head-mounted device 10 may forego displaying virtual object 80 once the physical object 62 is in target depth range 66.

Thus far, examples have been described where a physical object is positioned outside of a target depth range for OCR. Instead or in addition, a surface with text on a physical object may be angled relative to camera 22 in a manner that reduces the accuracy of the OCR. FIG. 12A is a view of a physical object 62 that is within target depth range 66 but angled way from head-mounted device 10. For optimal OCR, the surface normal 82 of physical object 62 may face head-mounted device 10 (and the accompanying camera 22). In FIG. 12A, surface normal 82 is not facing head-mounted device 10.

During operation of head-mounted device 10, images from camera 22 may be used to estimate the angle of surface normal 82 relative to a forward vector of camera 22. When surface normal 82 is parallel to the forward vector of camera 22, the angle of surface normal 82 relative to the forward vector of camera 22 may be defined as 0 degrees. As the object is tilted away from the camera, the absolute value of the angle between surface normal 82 and the forward vector 82 of camera 22 will gradually increase. Similar to how there may be a target depth range for OCR, there may be a target angular range for OCR. The physical object may need to be within the target angular range to be captured by camera 22 with sufficient clarity for optical character recognition.

To provide the user with feedback that the angle of the physical object is non-ideal for OCR, visual and/or audio feedback may be provided. As shown in FIG. 12B, text feedback 74 may be presented on display 18 and may include text such as “tilt object to face camera,” “adjust angle of object,” etc. Any other desired visual and/or audio feedback may be presented by head-mounted device 10 in response to a determination (e.g., using camera 22 and/or depth sensor 28) that the surface normal 82 of physical object 62 is not facing head-mounted device 10. The determination that the surface normal 82 of physical object 62 is not facing head-mounted device 10 may include a determination that the angle of surface normal 82 relative to the forward vector of camera 22 is outside the aforementioned target angular range.

It is noted that the visual indicator may initially not be aligned with the object. For example, the visual indicator may be presented at a baseline depth and/or at a baseline position relative to the physical environment. The visual indicator may optionally be presented even when no objects are detected. When an object is detected, the visual indicator may optionally be repositioned (e.g., the depth and/or position relative to the physical environment) to be aligned with the object. When aligned with the object, the visual indicator may have a depth that matches the depth of the object and/or may form a partial or complete outline around the object. In one possible arrangement, the visual indicator may only be aligned with the object when the object is within the target depth range. Until the object is within the target depth range, the visual indicator may remain at a baseline position, may remain at a baseline depth, etc. When the visual indicator is updated to be aligned with the object, the visual indicator may move gradually (e.g., in an animation).

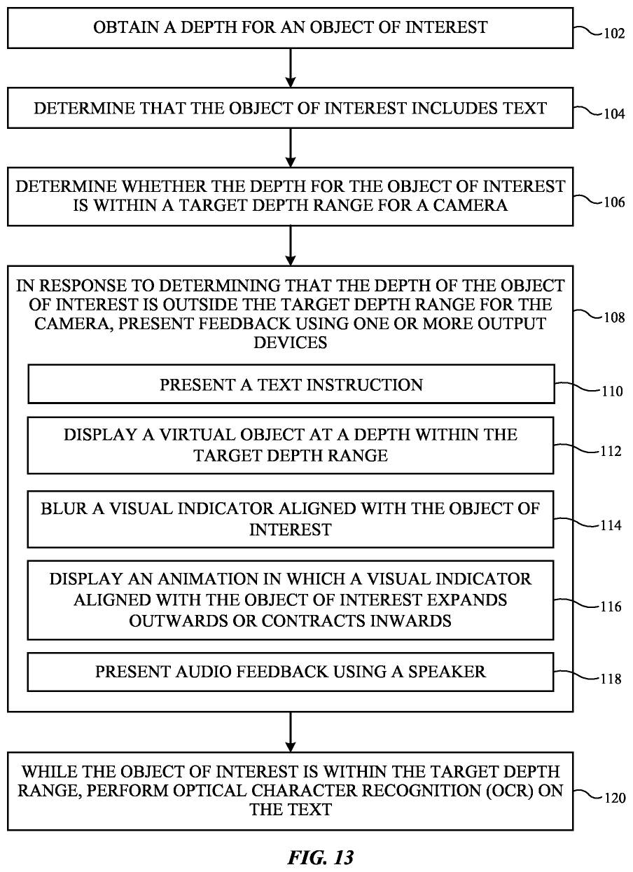

FIG. 13 is a flowchart showing an illustrative method for operating an electronic device that presents feedback when an object of interest is outside a target depth range. First, at block 102, head-mounted device 10 obtains a depth for an object of interest. The object of interest may be a physical object within the field-of-view of the user. The head-mounted device 10 may obtain the depth using one or more depth sensors 28 (e.g., a LIDAR sensor), using camera 22, and/or using other desired techniques.

Head-mounted device 10 may optionally determine the depth of the object of interest using temporal information. This type of temporal information may enable the head-mounted device 10 to provide feedback regarding the position of the text even when the camera cannot identify text at a current (real-time) position. For example, camera 22 may identify text on a physical object in the target depth range. Camera 22 may identify that the text becomes larger over time while in the target depth range. This implies that the detected text was moving towards the head-mounted device when the text exited the target depth range. Accordingly, head-mounted device 10 may determine that the text is closer than the target depth range once the text is no longer in the target depth range. Head-mounted device 10 may also assume that the physical object that recently exited the target depth range includes text, even if a real-time analysis of an image of the physical object does not identify text. As another example, camera 22 may detect that text becomes smaller over time while in the target depth range. Accordingly, head-mounted device 10 may determine that the text is further than the target depth range once the text is no longer in the target depth range (even if a real-time analysis of an image of the physical object does not identify text).

At block 104, head-mounted device 10 may determine that the object of interest includes text. Head-mounted device 10 may use images from camera 22 to identify text in the physical environment. The head-mounted device may be able to identify text even when the text is outside the target depth range for camera 22. Outside the target depth range, the head-mounted device 10 may identify text is present but may not be able to perform OCR accurately. Determining the depth may include determining a specific depth (e.g., in meters) or determining whether the depth is less than or greater than the target depth range (without necessary determining a specific depth magnitude).

If desired, the order of blocks 102 and 104 may be reversed. In one possible arrangement, head-mounted device 10 may only obtain the depth for an object of interest in response to determining that the object of interest includes text.

At block 106, head-mounted device 10 (e.g., control circuitry 14) may determine whether the depth for the object of interest is within a target depth range for camera 22. The target depth range for camera 22 may be stored in memory on head-mounted device 10.

In response to determining that the depth of the object of interest is outside the target depth range for the camera, head-mounted device 10 may, at block 108, present feedback using one or more output devices such as display 18 and speaker 20. As previously discussed, there are numerous possible types of feedback that may be presented to the user.

In one example (as in block 110), display 18 may present a visible text instruction. The visible text instruction may instruct the user to move the physical object closer or further from the head-mounted device in order to position the physical object within the target depth range.

In another example (as in block 112), display 18 may display a virtual object at a depth (e.g., a perceived depth) that is within the target depth range. The virtual object being positioned within the target depth range may serve as a visual indicator for the user as to where to move the physical object. Head-mounted device 10 may forego displaying the virtual object once the physical object enters the target depth range. Blocks 110 and 112 may combined if desired. For example, a text instruction may be displayed in parallel with the virtual object with an instruction to “align the text with the virtual object,” or similar text.

In another example (as in block 114), display 18 may blur a visual indicator that is aligned with the object of interest. The visual indicator may form at least a partial outline around the physical object (from the perspective of the viewer). The magnitude of the blur applied to the visual indicator may be proportional to a difference between the depth of the physical object and the target depth range.

In another example (as in block 116), display 18 may present an animation in which a visual indicator that is aligned with the object of interest either expands outwards or contracts inwards. The visual indicator may form at least a partial outline around the physical object (from the perspective of the viewer). The animation in which the visual indicator expands outwards may be presented when the depth of the physical object is greater than the target depth range. The animation in which the visual indicator contracts inwards may be presented when the depth of the physical object is less than the target depth range.

In another example (as in block 118), speaker 20 may present audio feedback. The audio feedback may include audio instructions (e.g., an audio version of any of the text instructions described herein), chimes, or other desired audio feedback.

Multiple types of feedback may be presented simultaneously at block 108. In general, any of the types of feedback described herein may be presented in any combination at block 108. The feedback presented at block 108 may include presenting feedback without presenting an image from the camera on display 18. If desired, the feedback presented at block 108 may only be presented in response to the determination that the object of interest includes text at block 104. If desired, the appearance of visual indicator 72 may only be changed at block 108 in response to the determination that the object of interest includes text at block 104.

It is noted that the feedback presented at block 108 may be presented even if the object of interest can no longer be identified as text (e.g., due to being too close or too far away). Consider an example where the object of interest is identified to include text at a first time and while at a first depth. At a second time subsequent to the first time, the object of interest may still be identified to include text and may be identified at a second depth that is closer than the first depth. At a third time subsequent to the second time, the object of interest may be identified at a third depth that is closer than the second depth and may no longer be identified to include text (e.g., at this instant the object is too close for the text to be identifiable). However, the progression of the object (with identified text) over time towards the viewer may be used to infer that the text is still present on the object (even though the text cannot be identified at the current depth). In other words, temporal tracking of the depth of the object of interest may be used to infer the presence of text in situations where it would otherwise not be easily detectable. In these types of situations, feedback may be presented using any or all of the techniques of block 108.

At block 120, head-mounted device 10 may perform OCR on the text while the object of interest is within the target depth range.

Consider an example where a business card is held in front of the head-mounted device. At block 102, head-mounted device 10 may obtain a depth for the business card. The head-mounted device 10 may obtain the depth using data from a depth sensor 28 or using images from camera 22. Next, at block 104, head-mounted device 10 may identify text on the business card. For example, initially the business card may be within the target depth range and text may be detected on the business card in images from camera 22. Alternatively, initially the business card may be outside the target depth range and text may be detected on the business card in images from camera 22 (even though the images are not clear enough for OCR). At block 106, head-mounted device may determine whether the depth of the business card is within a target depth range for camera 22. Head-mounted device 10 may identify that the business card is moving towards or away from the head-mounted device when the business card exits the target depth range, as an example. Using this temporal information, head-mounted device 10 may know that the business card includes text even when the real-time images from camera 22 cannot identify text. Next, at block 108, head-mounted device 10 may blur visual indicator 72 aligned with the business card in response to determining that the depth of the business card is outside of the target depth range for camera 22. At block 120, while the business card is within the target depth range, the head-mounted device may perform OCR on the identified text.

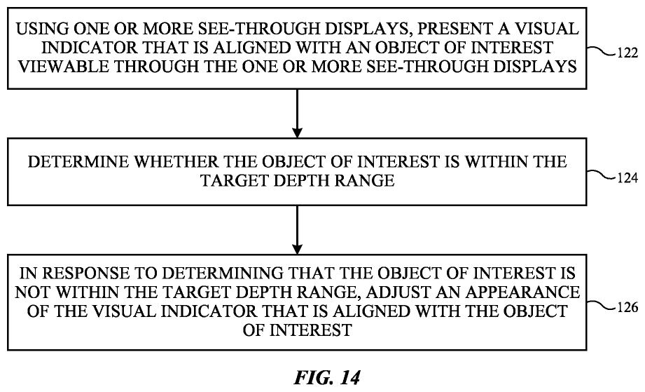

FIG. 14 is a flowchart showing an illustrative method for operating an electronic device that changes the appearance of a visual indicator that is aligned with a physical object when the physical object is outside a target depth range. First, at block 122, head-mounted device 10 may present, using see-through display 18, a visual indicator that is aligned with an object of interest that is viewable through the see-through display. The visual indicator may form at least a partial outline around the physical object (from the perspective of the viewer). The visual indicator may have four discrete corner pieces (as in FIG. 5) or another desired shape.

Next, at block 124, head-mounted device 10 may determine whether the object of interest is within the target depth range of camera 22. Then, at block 126, in response to determining that the object of interest is not within the target depth range, head-mounted device 10 may adjust an appearance of the visual indicator that is aligned with the object of interest. Adjusting the appearance of the visual indicator may include blurring the visual indicator, presenting an animation in which the visual indicator is expanded outward, and/or presenting an animation in which the visual indicator is contracted inward.

Consider an example where a business card is held in front of the head-mounted device. At block 122, head-mounted device 10 may, using see-through display 18, present a visual indicator that is aligned with the business card when viewed through the see-through display. Next, at block 124, head-mounted device 10 may determine whether the business card is within the target depth range (e.g., using depth sensor 28, images from camera 22, etc.). Finally, at block 126, head-mounted device 10 may blur the visual indicator that is aligned with the business card when viewed through the see-through display. Blurring the visual indicator in this manner provides feedback to the user that the business card is not within the target depth range for OCR.

The order of blocks in FIGS. 13 and 14 is merely illustrative and the blocks may be performed in different orders if desired. Moreover, one or more blocks may be omitted from FIGS. 13 and 14 if desired.

Thus far, providing feedback to a user regarding the position of a physical object relative to a target depth range has been described relative to the use case of text and OCR. This example is merely illustrative. In general, feedback of the types described herein may be presented when any type of object is outside the target depth range. One specific alternative is facial recognition analysis. Head-mounted device 10 may determine, using images from camera 22, that an object of interest includes a face. When the face is outside of the target depth range, the head-mounted device may be able to identify that a face is present but may not be able to perform facial recognition analysis with high accuracy. The head-mounted device may only be able to perform facial recognition analysis with a target accuracy when the face is within the target depth range. When applied to facial recognition analysis, the blocks of FIG. 13 may be the same as already described except block 104 includes determining that the object of interest includes a face and block 120 includes performing facial recognition analysis. When applied to facial recognition analysis, the blocks of FIG. 14 may be the same as already described.

As described above, one aspect of the present technology is the gathering and use of information such as sensor information. The present disclosure contemplates that in some instances, data may be gathered that includes personal information data that uniquely identifies or can be used to contact or locate a specific person. Such personal information data can include demographic data, location-based data, telephone numbers, email addresses, twitter ID's, home addresses, data or records relating to a user's health or level of fitness (e.g., vital signs measurements, medication information, exercise information), date of birth, username, password, biometric information, or any other identifying or personal information.

The present disclosure recognizes that the use of such personal information, in the present technology, can be used to the benefit of users. For example, the personal information data can be used to deliver targeted content that is of greater interest to the user. Accordingly, use of such personal information data enables users to have control of the delivered content. Further, other uses for personal information data that benefit the user are also contemplated by the present disclosure. For instance, health and fitness data may be used to provide insights into a user's general wellness, or may be used as positive feedback to individuals using technology to pursue wellness goals.

The present disclosure contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. Such policies should be easily accessible by users, and should be updated as the collection and/or use of data changes. Personal information from users should be collected for legitimate and reasonable uses of the entity and not shared or sold outside of those legitimate uses. Further, such collection/sharing should occur after receiving the informed consent of the users. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations. For instance, in the United States, collection of or access to certain health data may be governed by federal and/or state laws, such as the Health Insurance Portability and Accountability Act (HIPAA), whereas health data in other countries may be subject to other regulations and policies and should be handled accordingly. Hence different privacy practices should be maintained for different personal data types in each country.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, the present technology can be configured to allow users to select to “opt in” or “opt out” of participation in the collection of personal information data during registration for services or anytime thereafter. In another example, users can select not to provide certain types of user data. In yet another example, users can select to limit the length of time user-specific data is maintained. In addition to providing “opt in” and “opt out” options, the present disclosure contemplates providing notifications relating to the access or use of personal information. For instance, a user may be notified upon downloading an application (“app”) that their personal information data will be accessed and then reminded again just before personal information data is accessed by the app.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user's privacy. De-identification may be facilitated, when appropriate, by removing specific identifiers (e.g., date of birth, etc.), controlling the amount or specificity of data stored (e.g., collecting location data at a city level rather than at an address level), controlling how data is stored (e.g., aggregating data across users), and/or other methods.

Therefore, although the present disclosure broadly covers use of information that may include personal information data to implement one or more various disclosed embodiments, the present disclosure also contemplates that the various embodiments can also be implemented without the need for accessing personal information data. That is, the various embodiments of the present technology are not rendered inoperable due to the lack of all or a portion of such personal information data.

The foregoing is merely illustrative and various modifications can be made to the described embodiments. The foregoing embodiments may be implemented individually or in any combination.

What is claimed is:

1. An electronic device comprising:
one or more sensors, wherein the one or more sensors comprises a camera with an associated target depth range;
one or more see-through displays;
one or more processors; and
memory storing instructions configured to be executed by the one or more processors, the instructions for:
using the one or more see-through displays, presenting a visual indicator that is aligned with an object of interest viewable through the one or more see-through displays;
determining whether the object of interest is within the target depth range; and
in response to determining that the object of interest is not within the target depth range, adjusting an appearance of the visual indicator that is aligned with the object of interest.

2. The electronic device defined in claim 1, wherein adjusting the appearance of the visual indicator comprises blurring the visual indicator and wherein presenting the visual indicator comprises presenting the visual indicator without presenting an image from the camera.

3. The electronic device defined in claim 1, wherein determining that the object of interest is not within the target depth range comprises determining that the object of interest is not within the target depth range using one or more images from the camera.

4. The electronic device defined in claim 1, wherein the one or more sensors comprises a depth sensor and wherein determining that the object of interest is not within the target depth range comprises determining that the object of interest is not within the target depth range using the depth sensor.

5. The electronic device defined in claim 1, wherein the instructions further comprise instructions for:
in response to determining that the object of interest has a depth that is greater than the target depth range, displaying an animation in which the visual indicator expands outwards; and
in response to determining that the object of interest has a depth that is less than the target depth range, displaying an animation in which the visual indicator contracts inwards.

6. The electronic device defined in claim 1, wherein the instructions further comprise instructions for:
determining, using images captured by the camera, that the object of interest includes text, wherein presenting the visual indicator that is aligned with the object of interest comprises presenting the visual indicator that is aligned with the object of interest in response to determining that the object of interest includes the text and wherein adjusting the appearance of the visual indicator that is aligned with the object of interest comprises adjusting the appearance of the visual indicator that is aligned with the object of interest in response to determining that the object of interest includes the text; and
while the object of interest is within the target depth range, performing optical character recognition (OCR) on the text.

7. The electronic device defined in claim 1, wherein adjusting the appearance of the visual indicator comprises:
increasing a blur of the visual indicator in response to the object of interest moving further from the target depth range; and
decreasing a blur of the visual indicator in response to the object of interest moving closer to the target depth range.

8. The electronic device defined in claim 1, wherein the instructions further comprise instructions for:
determining an angle of the object of interest relative to the camera; and
presenting feedback regarding the angle using the one or more output devices.

9. A method of operating an electronic device that comprises one or more sensors and one or more see-through displays, wherein the one or more sensors comprises a camera with an associated target depth range and wherein the method comprises:
using the one or more see-through displays, presenting a visual indicator that is aligned with an object of interest viewable through the one or more see-through displays;
determining whether the object of interest is within the target depth range; and
in response to determining that the object of interest is not within the target depth range, adjusting an appearance of the visual indicator that is aligned with the object of interest.

10. The method defined in claim 9, wherein adjusting the appearance of the visual indicator comprises blurring the visual indicator and wherein presenting the visual indicator comprises presenting the visual indicator without presenting an image from the camera.

11. The method defined in claim 9, wherein determining that the object of interest is not within the target depth range comprises determining that the object of interest is not within the target depth range using one or more images from the camera.

12. The method defined in claim 9, wherein the one or more sensors comprises a depth sensor and wherein determining that the object of interest is not within the target depth range comprises determining that the object of interest is not within the target depth range using the depth sensor.

13. The method defined in claim 9, further comprising:
in response to determining that the object of interest has a depth that is greater than the target depth range, displaying an animation in which the visual indicator expands outwards; and
in response to determining that the object of interest has a depth that is less than the target depth range, displaying an animation in which the visual indicator contracts inwards.

14. The method defined in claim 9, further comprising:
determining, using images captured by the camera, that the object of interest includes text, wherein presenting the visual indicator that is aligned with the object of interest comprises presenting the visual indicator that is aligned with the object of interest in response to determining that the object of interest includes the text and wherein adjusting the appearance of the visual indicator that is aligned with the object of interest comprises adjusting the appearance of the visual indicator that is aligned with the object of interest in response to determining that the object of interest includes the text; and
while the object of interest is within the target depth range, performing optical character recognition (OCR) on the text.

15. The method defined in claim 9, wherein adjusting the appearance of the visual indicator comprises:
increasing a blur of the visual indicator in response to the object of interest moving further from the target depth range; and
decreasing a blur of the visual indicator in response to the object of interest moving closer to the target depth range.

16. The method defined in claim 9, further comprising:
determining an angle of the object of interest relative to the camera; and
presenting feedback regarding the angle using the one or more output devices.

17. A non-transitory computer-readable storage medium storing one or more programs configured to be executed by one or more processors of an electronic device that comprises one or more sensors and one or more see-through displays, wherein the one or more sensors comprises a camera with an associated target depth range and wherein the one or more programs including instructions for:
using the one or more see-through displays, presenting a visual indicator that is aligned with an object of interest viewable through the one or more see-through displays;
determining whether the object of interest is within the target depth range; and
in response to determining that the object of interest is not within the target depth range, adjusting an appearance of the visual indicator that is aligned with the object of interest.

18. The non-transitory computer-readable storage medium defined in claim 17, wherein adjusting the appearance of the visual indicator comprises blurring the visual indicator and wherein presenting the visual indicator comprises presenting the visual indicator without presenting an image from the camera.

19. The non-transitory computer-readable storage medium defined in claim 17, wherein determining that the object of interest is not within the target depth range comprises determining that the object of interest is not within the target depth range using one or more images from the camera.

20. The non-transitory computer-readable storage medium defined in claim 17, wherein the one or more sensors comprises a depth sensor and wherein determining that the object of interest is not within the target depth range comprises determining that the object of interest is not within the target depth range using the depth sensor.

21. The non-transitory computer-readable storage medium defined in claim 17, wherein the instructions further comprise instructions for:
in response to determining that the object of interest has a depth that is greater than the target depth range, displaying an animation in which the visual indicator expands outwards; and
in response to determining that the object of interest has a depth that is less than the target depth range, displaying an animation in which the visual indicator contracts inwards.

22. The non-transitory computer-readable storage medium defined in claim 17, wherein the instructions further comprise instructions for:
determining, using images captured by the camera, that the object of interest includes text, wherein presenting the visual indicator that is aligned with the object of interest comprises presenting the visual indicator that is aligned with the object of interest in response to determining that the object of interest includes the text and wherein adjusting the appearance of the visual indicator that is aligned with the object of interest comprises adjusting the appearance of the visual indicator that is aligned with the object of interest in response to determining that the object of interest includes the text; and
while the object of interest is within the target depth range, performing optical character recognition (OCR) on the text.

23. The non-transitory computer-readable storage medium defined in claim 17, wherein adjusting the appearance of the visual indicator comprises:
increasing a blur of the visual indicator in response to the object of interest moving further from the target depth range; and
decreasing a blur of the visual indicator in response to the object of interest moving closer to the target depth range.

24. The non-transitory computer-readable storage medium defined in claim 17, wherein the instructions further comprise instructions for:
determining an angle of the object of interest relative to the camera; and
presenting feedback regarding the angle using the one or more output devices.
